(19) United States
(12) Patent Application Publication
(10) Pub. No.: US 2026/0153319 A1
(43) Pub. Date: Jun. 4, 2026

(54) System for Measuring Contact Angle

(71) Applicant: Guizhou Power Grid Co., Ltd., Guiyang (CN)

(72) Inventors: Bo LI, Guiyang (CN); Jie BAI, Guiyang (CN); Jinhang HE, Guiyang (CN); Yuan YUAN, Guiyang (CN); Zhiming DING, Guiyang (CN); Xu DAI, Guiyang (CN)

(21) Appl. No.: 19/453,684

(22) Filed: Jan. 20, 2026

Related U.S. Application Data
(63) Continuation of application No. PCT/CN2024/139047, filed on Dec. 13, 2024.

(30) Foreign Application Priority Data
Jul. 3, 2024 (CN) 202410885377.3

(51) Int. Cl. G01B 3/56; G01B 5/24; G01N 13/00

(52) U.S. Cl. CPC G01B 3/56; G01B 5/24; G01N 13/00

(57) ABSTRACT

Disclosed in the present disclosure is a system for measuring a contact angle, belonging to the technical field of devices for measuring a contact angle. The system for measuring a contact angle includes: a fixed sleeve; a positioning assembly including a rotary sleeve, a reset member, and a slider, where the slider is provided with a protruding portion capable of extending into a gap on a surface of a cable; and a brake assembly including an abutting block, when the rotary sleeve is rotated to a preset angle, the abutting block can abut against the cable, which indicates to an operator that the cable reaches a sampling point. Accordingly, the rotary sleeve moves axially by a fixed length each time to make the preset angle the same, and fixed-point sampling is carried out on the cable.

### CROSS-REFERENCE TO RELATED APPLICATIONS

The present application is a continuation of International Application No. PCT/CN2024/139047, filed on Dec. 13, 2024, which claims priority to Chinese Patent Application No. 202410885377.3, filed on Jul. 3, 2024, the entire disclosure of which is incorporated herein by reference.

### TECHNICAL FIELD

The present disclosure relates to the technical field of devices for measuring a contact angle, in particular to a system for measuring a contact angle.

### BACKGROUND

Currently, miniature automatic portable contact angle measuring instruments can provide a more comprehensive understanding of the characteristics, such as chemical composition, microstructure, and roughness, of a surface of a sample by measuring contact angles at different positions on the sample during actual measurement. These surface characteristics have an important influence on the wettability of liquids and the sizes of the contact angles. Consequently, measuring the contact angles at different positions on the sample helps to evaluate the wettability, surface energy, and surface characteristics of material, providing a basis for material selection, surface modification, and quality control. Moreover, measuring the contact angles also helps to understand the interaction between the material and liquids or gases, and provides guidance for practical applications.

During measurement, a measuring instrument is usually placed directly on a sample to be measured, and then measurement operations are performed. However, during multi-point measurement on a sample, a tester needs to repeatedly pick up the measuring instrument and place it at a new measurement point for measurement. In this process, the adjustment of the position of the measuring instrument is entirely dependent on the subjective judgment of the tester. It is difficult to preset different measurement points based on the actual conditions of the sample and ensure that the measuring instrument can accurately move to designated measurement points during actual measurement. This method affects the reliability and accuracy of measurement results, and the subjective operations of the tester also increase errors.

### SUMMARY

An objective of the present part is to provide an overview of some aspects of examples of the present disclosure and a brief description of some preferred examples. Simplifications or omissions may be made in the present part as well as the abstract of the description and the title of invention of the present application, so as not to obscure the objective of the present part as well as the abstract of the description and the title of invention. However, such simplifications or omissions cannot be used to limit the scope of the present disclosure.

In view of the above and/or problems in the prior art, the present disclosure is provided.

Accordingly, a problem to be solved by the present disclosure lies in how to perform multi-point fixed-point sampling measurement on a cable.

In order to solve the above technical solution, the present disclosure provides the following technical solution: a system for measuring a contact angle includes: a fixed sleeve; a positioning assembly including a rotary sleeve rotatably mounted in the fixed sleeve, a reset member arranged on the fixed sleeve, and a slider elastically mounted on the rotary sleeve, where the reset member is in transmission connection to the slider, and the slider is provided with a protruding portion capable of extending into a gap on a surface of a cable; and a brake assembly including an abutting block elastically mounted on the fixed sleeve, where the abutting block is also in transmission connection to the reset member; and when the rotary sleeve is rotated to a preset angle, the abutting block can abut against the cable.

As a preferred solution of the system for measuring a contact angle in the present disclosure, a first mounting groove is formed in an inner circumferential wall of the rotary sleeve. The slider is elastically mounted in the first mounting groove. The protruding portion is located on an end surface of a side of the slider facing the cable.

As a preferred solution of the system for measuring a contact angle in the present disclosure, a second mounting groove is formed in an inner circumferential wall of the fixed sleeve. The second mounting groove has an annular shape. The reset member includes a coil spring. One end of the coil spring is snapped in an outer circumferential wall of the rotary sleeve. The other end of the coil spring is provided with a first snapping hook portion.

As a preferred solution of the system for measuring a contact angle in the present disclosure, a mounting post is arranged on an outer circumferential wall of the fixed sleeve. A mounting hole is formed in the mounting post. The reset member further includes a floating plate. The floating plate is elastically mounted in the mounting hole. One end of the floating plate close to the coil spring is provided with a second snapping hook portion. The second snapping hook portion is connected to the first snapping hook portion in a snap-fit manner. The coil spring is capable of pulling the floating plate towards the cable.

As a preferred solution of the system for measuring a contact angle in the present disclosure, the positioning assembly further includes a first transmission ring. A third mounting groove is formed in the inner circumferential wall of the fixed sleeve. The third mounting groove has an annular shape. The third mounting groove is in communication with the second mounting groove. The first transmission ring is rotatably mounted in the third mounting groove through a first torsion spring. An arc-shaped groove is formed in an inner circumferential wall of the first transmission ring. A first abutting post is arranged on the slider. The first abutting post abuts against the arc-shaped groove.

As a preferred solution of the system for measuring a contact angle in the present disclosure, the brake assembly further includes a second transmission ring. A fourth mounting groove is formed in the inner circumferential wall of the fixed sleeve. The fourth mounting groove has an annular shape. The fourth mounting groove is in communication with the second mounting groove. The second transmission ring is rotatably mounted in the fourth mounting groove through a second torsion spring. A shifting post is arranged on one side of the second transmission ring facing the abutting block. A second abutting post is arranged on the abutting block. The shifting post abuts against the second abutting post. The shifting post is used for pushing the abutting block to abut against the cable.

As a preferred solution of the system for measuring a contact angle in the present disclosure, one end of the floating plate close to the cable is further provided with an arc-shaped bump. One end of the first transmission ring facing the floating plate is provided with a first transmission post. One end of the second transmission ring facing the floating plate is provided with a second transmission post. The first transmission post and the second transmission post both abut against the arc-shaped bump. The arc-shaped bump is used for driving the first transmission ring and the second transmission ring to rotate.

As a preferred solution of the system for measuring a contact angle in the present disclosure, a floating ratchet block is elastically mounted in the mounting hole. A ratchet groove is formed at one end of the floating plate facing the floating ratchet block. The ratchet groove is used for being connected to the floating ratchet block in a snap-fit manner.

As a preferred solution of the system for measuring a contact angle in the present disclosure, the positioning assembly further includes an unlocking pull rope. The unlocking pull rope is connected to the floating ratchet block.

As a preferred solution of the system for measuring a contact angle in the present disclosure, the system for measuring a contact angle further includes: a support, where the fixed sleeve is arranged on the support; a control module; and a contact angle measuring instrument arranged on the support and electrically connected to the control module.

The present disclosure has the beneficial effects as follows: by rotating the rotary sleeve to the preset angle, the abutting block abuts against the cable, such that the rotary sleeve cannot continue to move axially, which indicates to an operator that the cable reaches a sampling point. Accordingly, the rotary sleeve moves axially by a fixed length each time, and fixed-point sampling is carried out on the cable.

### BRIEF DESCRIPTION OF DRAWINGS

In order to describe the technical solutions in examples of the present disclosure more clearly, the accompanying drawings required for describing the examples are briefly described below. Obviously, the accompanying drawings in the following description are merely some examples of the present disclosure. Those of ordinary skill in the art can also derive other accompanying drawings from these accompanying drawings without creative efforts. In the figures:

FIG. 1 is a use scenario diagram of a system for measuring a contact angle;

FIG. 2 is a schematic use scenario diagram of a system for measuring a contact angle;

FIG. 3 is a schematic diagram showing a case where a cable is located in a fixed sleeve according to a system for measuring a contact angle;

FIG. 4 is a structural diagram of a fixed sleeve, a positioning assembly and a brake assembly according to a system for measuring a contact angle;

FIG. 5 is a sectional view of FIG. 4;

FIG. 6 is a sectional view from another perspective of FIG. 4;

FIG. 7 is a structural diagram of a reset member according to a system for measuring a contact angle; and

FIG. 8 is a diagram of fitting of a first transmission ring and a second transmission ring according to a system for measuring a contact angle.

### DETAILED DESCRIPTION OF THE EMBODIMENTS

In order to make the above objectives, features, and advantages of the present disclosure clearer and more understandable, particular embodiments of the present disclosure will be described in detail below in conjunction with the accompanying drawings of the description.

In the following description, numerous concrete details are set forth in order to provide a thorough understanding of the present disclosure. However, the present disclosure may be implemented otherwise than as specifically described herein. Those skilled in the art can make similar developments without departing from the spirit of the present disclosure, and therefore the present disclosure is not to be limited by the specific examples disclosed below.

Secondly, reference herein to “an example” or “example” means a specific feature, structure, or characteristic that can be included in at least one embodiment of the present disclosure. The phase “in an example” at different places in the present description neither refers to the same example, nor is a separate or selective example mutually exclusive of other examples.

### Example 1

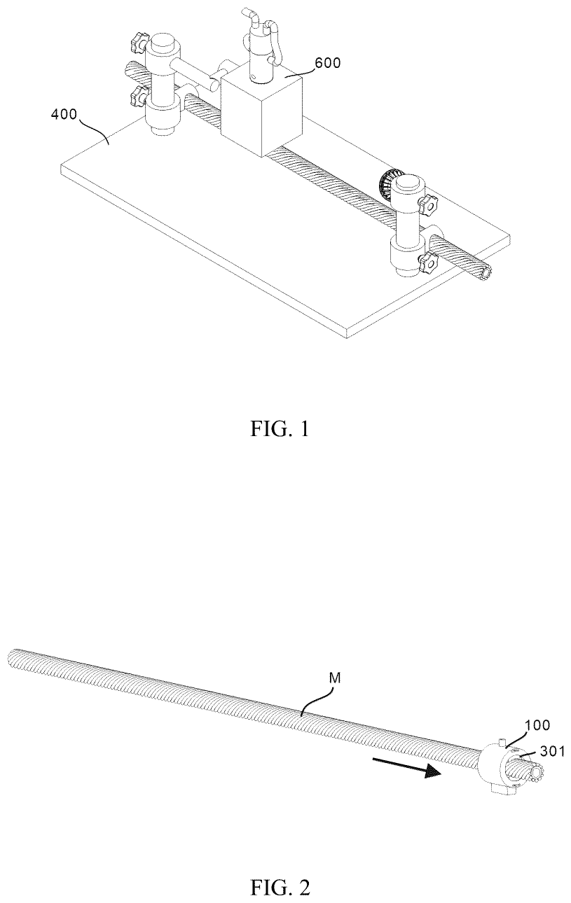

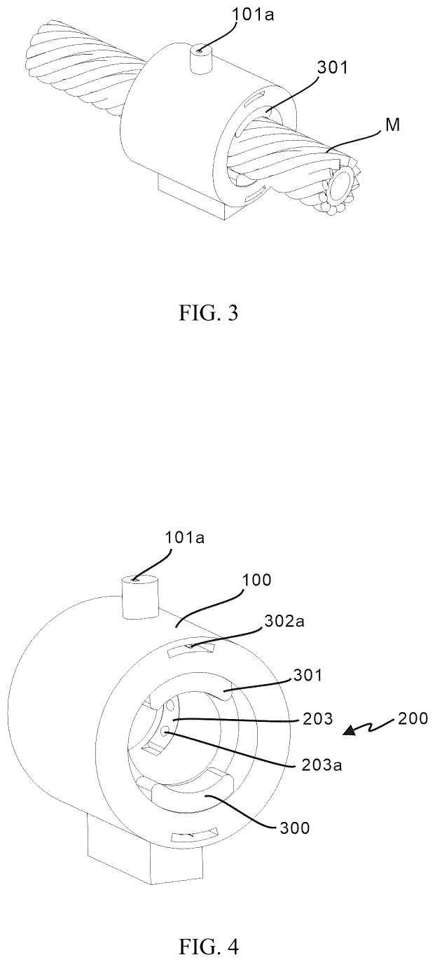

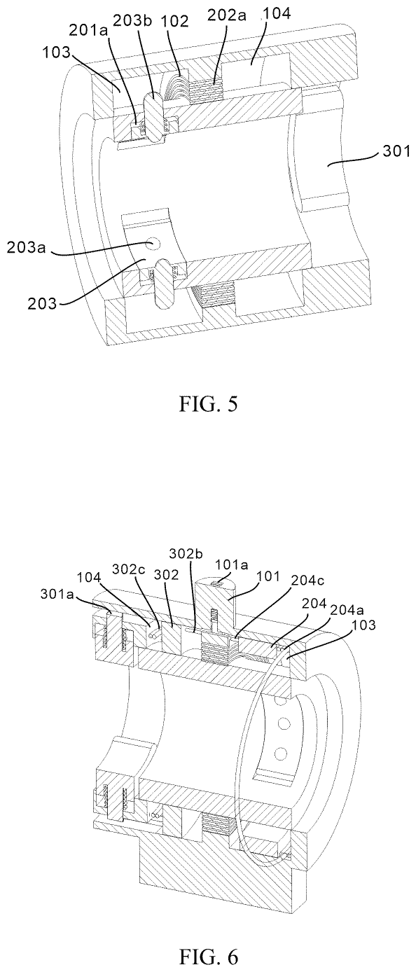

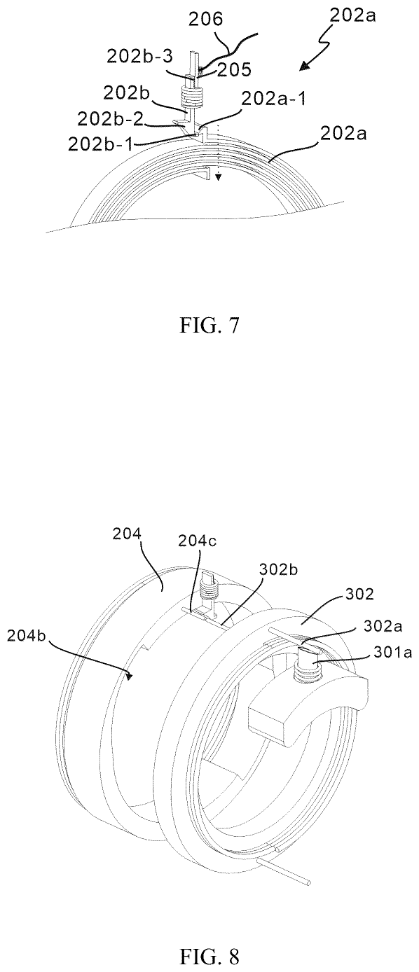

With reference to FIG. 1 to FIG. 8, a first example of the present disclosure is provided. The example provides a system for measuring a contact angle. The system for measuring a contact angle includes a fixed sleeve 100, a positioning assembly 200 and a brake assembly 300. The fixed sleeve 100 is used for allowing the positioning assembly 200 and the brake assembly 300 to be mounted. The positioning assembly 200 moves by a fixed distance relative to a length direction of the cable. After the positioning assembly 200 moves by a fixed distance relative to the cable, the brake assembly 300 is used for clamping the cable to perform braking.

Specifically, the fixed sleeve 100 has a cylindrical shape, is hollow in interior, and has opening at two ends. The cable passes through the fixed sleeve 100. The fixed sleeve 100 coincides with a central axis of the cable. When in use, an operator holds the fixed sleeve 100, such that the fixed sleeve 100 is fixed circumferentially.

The positioning assembly 200 includes a rotary sleeve 201 rotatably mounted in the fixed sleeve 100, a reset member 202 arranged on the fixed sleeve 100, and a slider 203 elastically mounted on the rotary sleeve 201. The reset member 202 is in transmission connection to the slider 203. The slider 203 is provided with a protruding portion 203a capable of extending into a gap on a surface of a cable M. The rotary sleeve 201 has a cylindrical shape, is hollow in interior, and has opening at two ends. The cable passes through the rotary sleeve 201. The rotary sleeve 201 coincides with the central axis of the cable. When an operator pulls the cable, the rotary sleeve 201 moves relative to the cable. The protruding portion 203a of the slider 203 is fitted to a gap on the surface of the cable M. The rotary sleeve 201 is driven to rotate circumferentially while moving axially relative to the cable M. When the rotary sleeve 201 is rotated circumferentially, the reset member 202 is driven to be tightened. After the rotary sleeve 201 is rotated to a preset angle, which is 20° in the example, under a reset force of the reset member 202, the rotary sleeve 201 is rotated back to an initial angle.

The brake assembly 300 includes an abutting block 301 elastically mounted on the fixed sleeve 100. The abutting block 301 is also in transmission connection to the reset member 202. When the rotary sleeve 201 is rotated to a preset angle, the abutting block 301 abuts against the cable M for fixing.

Preferably, a first mounting groove is formed in an inner circumferential wall of the rotary sleeve 201. The slider 203 is elastically mounted in the first mounting groove. The protruding portion 203a is located on an end surface of a side of the slider 203 facing the cable M. When the slider 203 loses resistance of an external force, the slider 203 can retract into the first mounting groove 201a under action of an elastic force. In this case, the protruding portion 203a loses the fit to the gap on the surface of the cable M.

Preferably, a second mounting groove 102 is formed in an inner circumferential wall of the fixed sleeve 100. The second mounting groove 102 has an annular shape. The reset member 202 includes a coil spring 202a. One end of the coil spring 202a is snapped in an outer circumferential wall of the rotary sleeve 201. The other end of the coil spring 202a is provided with a first snapping hook portion 202a-1. When the rotary sleeve 201 is rotated circumferentially, the coil spring 202a can be driven to be tightened.

Preferably, a mounting post 101 is arranged on an outer circumferential wall of the fixed sleeve 100. A mounting hole 101a is formed in the mounting post 101. The reset member 202 further includes a floating plate 202b. The floating plate 202b is elastically mounted in the mounting hole 101a. One end of the floating plate 202b close to the coil spring 202a is provided with a second snapping hook portion 202b-1. The second snapping hook portion 202b-1 is connected to the first snapping hook portion 202a-1 in a snap-fit manner. The coil spring 202a is capable of pulling the floating plate 202b towards the cable M. After the rotary sleeve 201 of the example is rotated by 19° circumferentially, the floating plate 202b can be pulled to move towards the cable M.

Preferably, the positioning assembly 200 further includes a first transmission ring 204. A third mounting groove 103 is formed in the inner circumferential wall of the fixed sleeve 100. The third mounting groove 103 has an annular shape. The third mounting groove 103 is in communication with the second mounting groove 102. The first transmission ring 204 is rotatably mounted in the third mounting groove 103 through a first torsion spring 204a. An arc-shaped groove 204b is formed in an inner circumferential wall of the first transmission ring 204. A first abutting post 203b is formed on the slider 203. The first abutting post 203b abuts against the arc-shaped groove 204b. When the first transmission ring 204 is rotated, the first transmission ring drives the arc-shaped groove 204b to rotate. The first abutting post 203b gradually retracts into the first mounting groove 201a under action of an elastic force.

Preferably, the brake assembly 300 further includes a second transmission ring 302. A fourth mounting groove 104 is formed in the inner circumferential wall of the fixed sleeve 100. The fourth mounting groove 104 has an annular shape. The fourth mounting groove 104 is in communication with the second mounting groove 102. The second transmission ring 302 is rotatably mounted in the fourth mounting groove 104 through a torsion spring. A shifting post 302a is arranged on one side of the second transmission ring 302 facing the abutting block 301. A second abutting post 301a is arranged on the abutting block 301. The shifting post 302a abuts against the second abutting post 301a. The shifting post 302a is used for pushing the abutting block 301 to abut against the cable M. When the second transmission ring 302 is rotated, the abutting block 301 is gradually driven to move towards the cable M by cooperation between the shifting post 302a and the second abutting post 301a until the abutting block abuts against the cable M.

Preferably, one end of the floating plate 202b close to the cable M is further provided with an arc-shaped bump 202b-2. One end of the first transmission ring 204 facing the floating plate 202b is provided with a first transmission post 204c. One end of the second transmission ring 302 facing the floating plate 202b is provided with a second transmission post 302b. The first transmission post 204c and the second transmission post 302b both abut against the arc-shaped bump 202b-2. The arc-shaped bump 202b-2 is used for driving the first transmission ring 204 and the second transmission ring 302 to rotate. When the rotary sleeve 201 is rotated 19° circumferentially, the floating plate 202 b can be pulled to move towards the cable M. During movement of the floating plate 202b towards the cable M, the arc-shaped bump 202b-2 presses the first transmission post 204c and the second transmission post 302b, thereby driving the first transmission ring 204 and the second transmission ring 302 to rotate.

Preferably, a floating ratchet block 205 is elastically mounted in the mounting hole 101a. A ratchet groove 202b-3 is formed at one end of the floating plate 202b facing the floating ratchet block 205. The ratchet groove 202b-3 is used for being connected to the floating ratchet block 205 in a snap-fit manner. When the floating plate 202b moves towards the cable M, the floating ratchet block 205 does not block movement of the floating plate 202b, but blocks movement of the floating plate 202b in an opposite direction.

Preferably, the positioning assembly 200 further includes an unlocking pull rope 206. The unlocking pull rope 206 is connected to the floating ratchet block 205. An operator pulls the pull rope 206 to disengage the floating ratchet block 205 from the ratchet groove 202b-3.

Furthermore, the system for measuring a contact angle further includes: a support 400, where the fixed sleeve 100 is arranged on the support 400; a control module 500; and a contact angle measuring instrument 600 arranged on the support 400 and electrically connected to the control module 500.

In order to facilitate understanding of the technical solution of the present disclosure, a brief description of a working process of the technical solution is given below:
An operator pulls the cable M by hand, such that the cable M and the fixed sleeve move axially relative to each other. In a process of pulling the cable M, the protruding portion 203a slides along the gap on the surface of the cable M, to drive the rotary sleeve 201 to rotate. When the rotary sleeve 201 is rotated to a preset angle, the coil spring 202a is tightened, and the second snapping hook portion 202b-1 of the coil spring 202a drives the floating plate 202b to move downwards by pulling the first snapping hook portion 202a-1. Thus, the arc-shaped bump 202b-2 on the floating plate 202b drives the first transmission ring 204 to rotate by pressing the first transmission post 204c, and drives the second transmission ring 302 to rotate by pressing the second transmission post 302b.

After the first transmission ring 204 is rotated, the slider 203 loses its restriction and retracts in the first mounting groove 201a under an elastic force. In this case, the protruding portion 203a make no contact with the gap on the surface of the cable M. Under the reset force of the coil spring 202a, the rotary sleeve 201 is rotated and returns to an initial position.

After the second transmission ring 302 is rotated, the abutting block 301 is driven to abut against the cable M. In this case, the rotary sleeve 201 cannot move axially relative to the cable M, this indicates to the operator that the cable M has moved to a sampling point.

Then, the unlocking pull rope 206 is pulled. The floating ratchet block 205 is disengaged from the ratchet groove 202b-3. The floating plate 202b is reset upwards. The first transmission ring 204 is reset under action of the first torsion spring 204a, the second transmission ring 302 is reset under action of the second torsion spring 302c.

It should be noted that the above examples are merely used to explain the technical solutions of the present disclosure and are not intended to limit the present disclosure. Although the present disclosure is described in detail with reference to the preferred examples, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the claims of the present disclosure.

What is claimed is:

1. A system for measuring a contact angle, comprising:
a fixed sleeve;
a positioning assembly comprising a rotary sleeve rotatably mounted in the fixed sleeve, a reset member arranged on the fixed sleeve, and a slider elastically mounted on the rotary sleeve, wherein the reset member is in transmission connection to the slider, and the slider is provided with a protruding portion capable of extending into a gap on a surface of a cable; and
a brake assembly comprising an abutting block elastically mounted on the fixed sleeve, wherein the abutting block is also in transmission connection to the reset member; and when the rotary sleeve is rotated to a preset angle, the abutting block abuts against the cable.

2. The system for measuring a contact angle according to claim 1, wherein a first mounting groove is formed in an inner circumferential wall of the rotary sleeve; and the slider is elastically mounted in the first mounting groove, and the protruding portion is located on an end surface of a side of the slider facing the cable.

3. The system for measuring a contact angle according to claim 2, wherein a second mounting groove is formed in an inner circumferential wall of the fixed sleeve, and the second mounting groove has an annular shape; and the reset member comprises a coil spring, one end of the coil spring is snapped in an outer circumferential wall of the rotary sleeve, and the other end of the coil spring is provided with a first snapping hook portion.

4. The system for measuring a contact angle according to claim 3, wherein a mounting post is arranged on an outer circumferential wall of the fixed sleeve, and a mounting hole is formed in the mounting post; and the reset member further comprises a floating plate, the floating plate is elastically mounted in the mounting hole, one end of the floating plate close to the coil spring is provided with a second snapping hook portion, the second snapping hook portion is connected to the first snapping hook portion in a snap-fit manner, and the coil spring is capable of pulling the floating plate towards the cable.

5. The system for measuring a contact angle according to claim 4, wherein the positioning assembly further comprises a first transmission ring; a third mounting groove is formed in the inner circumferential wall of the fixed sleeve, the third mounting groove has an annular shape, and the third mounting groove is in communication with the second mounting groove; and the first transmission ring is rotatably mounted in the third mounting groove through a first torsion spring, an arc-shaped groove is formed in an inner circumferential wall of the first transmission ring, a first abutting post is arranged on the slider, and the first abutting post abuts against the arc-shaped groove.

6. The system for measuring a contact angle according to claim 5, wherein the brake assembly further comprises a second transmission ring; a fourth mounting groove is formed in the inner circumferential wall of the fixed sleeve, the fourth mounting groove has an annular shape, and the fourth mounting groove is in communication with the second mounting groove; and the second transmission ring is rotatably mounted in the fourth mounting groove through a second torsion spring, a shifting post is arranged on one side of the second transmission ring facing the abutting block, a second abutting post is arranged on the abutting block, the shifting post abuts against the second abutting post, and the shifting post is used for pushing the abutting block to abut against the cable.

7. The system for measuring a contact angle according to claim 6, wherein one end of the floating plate close to the cable is further provided with an arc-shaped bump, one end of the first transmission ring facing the floating plate is provided with a first transmission post, one end of the second transmission ring facing the floating plate is provided with a second transmission post, the first transmission post and the second transmission post both abut against the arc-shaped bump, and the arc-shaped bump is used for driving the first transmission ring and the second transmission ring to rotate.

8. The system for measuring a contact angle according to claim 7, wherein a floating ratchet block is elastically mounted in the mounting hole, a ratchet groove is formed at one end of the floating plate facing the floating ratchet block, and the ratchet groove is used for being connected to the floating ratchet block in a snap-fit manner.

9. The system for measuring a contact angle according to claim 8, wherein the positioning assembly further comprises an unlocking pull rope, and the unlocking pull rope is connected to the floating ratchet block.

10. The system for measuring a contact angle according to claim 9, further comprising:
a support, wherein the fixed sleeve is arranged on the support;
a control module; and
a contact angle measuring instrument arranged on the support and electrically connected to the control module.
